(19) United States
(12) Patent Application Publication
(10) Pub. No.: US 2008/0223913 A1
(43) Pub. Date: Sep. 18, 2008

(54) AUTOMOBILE SEAT SUPPORT CADDY DEVICE

(76) Inventor: Philip B. Nadeau, Unity, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/686,625

(22) Filed: Mar. 15, 2007

(51) Int. Cl. B65D 19/02; B60R 11/00; B65D 85/30

(52) U.S. Cl. 229/152; 224/275

(57) ABSTRACT

A wedge-shaped support caddy device suitably adapted to be placed on an automobile seat to provide a level surface on which to place objects, while also providing a container for smaller objects. The support caddy device is constructed of corrugated cardboard for strength, rigidity, durability, and low cost, and can be manufactured from a unitary sheet, thereby allowing for ease of storage until needed for use, when it can be folded into its intended configuration.

### BACKGROUND OF THE INVENTION

1. Technical Field

The present invention relates generally to the field of automobile accessories and more specifically to the field of automobile seat leveling and containment devices.

2. Description of Prior Art

Automobile seats are typically inclined, with the rear of the sitting surface of the automobile seat positioned lower than the front edge of the sitting surface, thereby creating a depression in the sitting surface towards the seat back. While this configuration has been found to provide greater comfort to persons sitting in automobile seats, it also results in an unsuitable surface for placing objects requiring a relatively level orientation. Placing large containers with liquid or semi-solid contents onto an inclined automobile seat, such as a crock pot containing a stew or a pizza box containing a hot pizza with melted cheese, often results in the contents of the container spilling or shifting in an unwanted manner (e.g., the cheese sliding off the top of the pizza). Open topped containers, such as potted seedling containers, are also subject to tipping and spilling when placed on an inclined automobile seat. There is thus a need for a support device suitable for placing onto the sitting surface of an inclined automobile seat to provide a substantially level surface onto which objects can be placed. There is also a need for a caddy device to contain small objects on an automobile seat so that they do not roll off the sitting surface. For greater efficiency, these two functions should be combined.

There exist various devices to provide a level surface to an automobile seat. For example, a solid foam wedge device has been used to provide a leveling base for baby car seats. However, such devices fail to provide a sufficient surface for supporting objects other than baby car seats. They also tend to compress unevenly due to their foam construction, thus defeating the purpose of providing a substantially level surface. They are relatively expensive to purchase and complex to manufacture. Moreover, if they become soiled cleaning is inconvenient and if they become damaged replacement becomes costly.

Car seat tray devices are also known in the art, with the basic design including a horizontal support surface with one or more legs depending downward from one end of the support surface in a substantially perpendicular orientation to the support surface. These trays are constructed of plastic or heavy gauge paper, such as cardboard. These trays are positioned on an automobile seat sitting surface with the legs placed proximate to the seat back. These trays work sufficiently well for supporting objects in a horizontal orientation, but do not provide a solution for retaining small objects on a sitting surface. The plastic trays are also costly to manufacture. The paper trays are less expensive but the perpendicular orientation of the legs to the support surfaces presents a potential weak point allowing collapse if heavy objects are placed thereon.

Other, more complex devices for providing a level support surface on an automobile seat are known. One such device uses an integrated inflatable air bladder attached to a container. The container is made level by the careful inflation of the air bladder. While this perhaps allows for very precise leveling, it is a costly, complicated piece of machinery requiring a power source.

Certain use-specific solutions have also been developed. For example, the prior art discloses pizza boxes with built-in flaps or legs, which when deployed cause the pizza box to be oriented much like the car seat tray devices previously discussed. However, these devices are limited to use with pizza and do not have general applicability.

There are also many different types of car caddies known in the art, but none that are also suitable for supporting larger objects on an inclined automobile seat in a horizontal orientation.

There is thus a need for an automobile seat support caddy device which is suitably adapted to support varied types of objects, is substantially rigid so as to not compress or deform, and is inexpensive and simple to manufacture. There is a further need for a disposable automobile seat support caddy device to eliminate cleaning or replacement concerns. There is a further need for an automobile seat support caddy device that can be used as a marketing tool by bearing vendor information on its surfaces. There is a further need for an automobile seat support caddy device that can also contain small objects while providing horizontal support to larger objects.

It is therefore an objective of this invention to provide an automobile seat support caddy device which is suitably adapted to support varied types of objects in a substantially horizontal orientation upon an inclined automobile seat sitting surface.

It is a further objective of this invention to provide an automobile seat support caddy device which is substantially rigid so as to not compress or deform when supporting objects.

It is yet a further objective of this invention to provide an automobile seat support caddy device which is inexpensive and simple to manufacture, ship, store, and use.

It is yet a further objective of this invention to provide an automobile seat support caddy device which is disposable to eliminate cleaning or replacement concerns

It is yet a further objective of this invention to provide an automobile seat support caddy device which can be used as a marketing tool by bearing vendor information on its surfaces.

It is yet a further objective of this invention to provide an automobile seat support caddy device which can contain small objects while providing horizontal support to large objects.

Other objectives of this invention will be evident from the following disclosure.

### SUMMARY

The present invention is an open wedge-shaped support caddy device for placing on an automobile seat. The support caddy device may be placed either open end up or open end down. The support caddy device provides both a level surface upon which to place objects and a contained space into which smaller objects may be placed. The open wedge shape of the support caddy device is formed by the combination of one support panel and three or more adjacent sides. Two lateral sides of the support caddy device are angled at the relatively same degree as the incline of the automobile seat; this causes the top edges at the open end of the device to lie substantially within a horizontal plane when the device is placed open end up, and causes the support panel of the device to lie substantially within a horizontal plane when the device is placed open end down. When placed open end up, smaller objects may be contained within the interior space of the support caddy device, with larger objects placed onto the edges, and when placed open end down larger objects may be placed on the support panel. Whether placed on the edges of the support caddy device or on the support panel, objects placed onto the support caddy device are oriented substantially horizontally.

The support caddy device is constructed of corrugated cardboard for strength, rigidity, and durability. Objects can be supported upon corrugated cardboard with a minimal amount of distortion to the material. The low cost of cardboard allows the support caddy device to be disposable, if desired. Ads and other marketing materials can also be printed on cardboard, making the support caddy device an excellent promotional tool for diverse businesses. The support caddy device further may be formed of a unitary sheet of corrugated cardboard, then folded into the appropriate shape at the time of use. This simplifies the manufacturing process, and also allows for easy shipping and storage, as the support caddy device can be left flat until needed for use.

Alternate embodiments of the support caddy device can include a cover. Use of the cover allows the support caddy device to be removed from the automobile environment without risk of losing any small objects placed within the interior of the support caddy device.

Other features and advantages of the invention are described below.

### DESCRIPTION OF THE DRAWINGS

FIG. 1 is a perspective view of the present invention, in support caddy mode.

FIG. 2 is a perspective cut-away view of the present invention in use on an automobile seat supporting an object in a substantially horizontal orientation in full support mode, with the present invention depicted with partial ghost lines and the automobile seat partially depicted.

FIG. 3A is a plan view of one embodiment of the present invention prior to assembly, depicting the various panels and fold lines.

FIG. 3B is a side view of the embodiment of the present invention depicted in FIG. 3A, oriented in full support mode.

FIG. 4A is a perspective view of the embodiment of the present invention depicted in FIG. 3A, depicting the various panels and fold lines as the device is partially folded.

FIG. 4B is a perspective view of the embodiment of the present invention depicted in FIG. 4A, depicting the final fold of the back panel and the first and second wings of the first and second side panels, respectively.

FIG. 4C is a side view and a close-up side view of the final interrelation between the back panel and the third wing of the second side panel.

FIG. 5A is a plan view of another embodiment of the present invention having a cover, depicting the various panels and fold lines of the base of the device and the cover.

FIG. 5B is a side view of the embodiment of the present invention depicted in FIG. 5A.

FIG. 6A is a plan view of another embodiment of the present invention having a narrower front end and a wider back end, depicting the various panels and fold lines.

FIG. 6B is a perspective view of the embodiment of the present invention depicted in FIG. 6A, oriented in full support mode.

FIG. 7A is a plan view of another embodiment of the present invention having a wider front end and a narrower back end, depicting the various panels and fold lines.

FIG. 7B is a perspective view of the embodiment of the present invention depicted in FIG. 7A, oriented in support caddy mode and containing small objects.

### DETAILED DESCRIPTION OF THE INVENTION

The present invention is a support caddy device 1 for placing on an automobile seat 10 sitting surface 12. It is intended to provide both a level surface upon which to place objects 20 and a contained space into which smaller objects 22 may be placed.

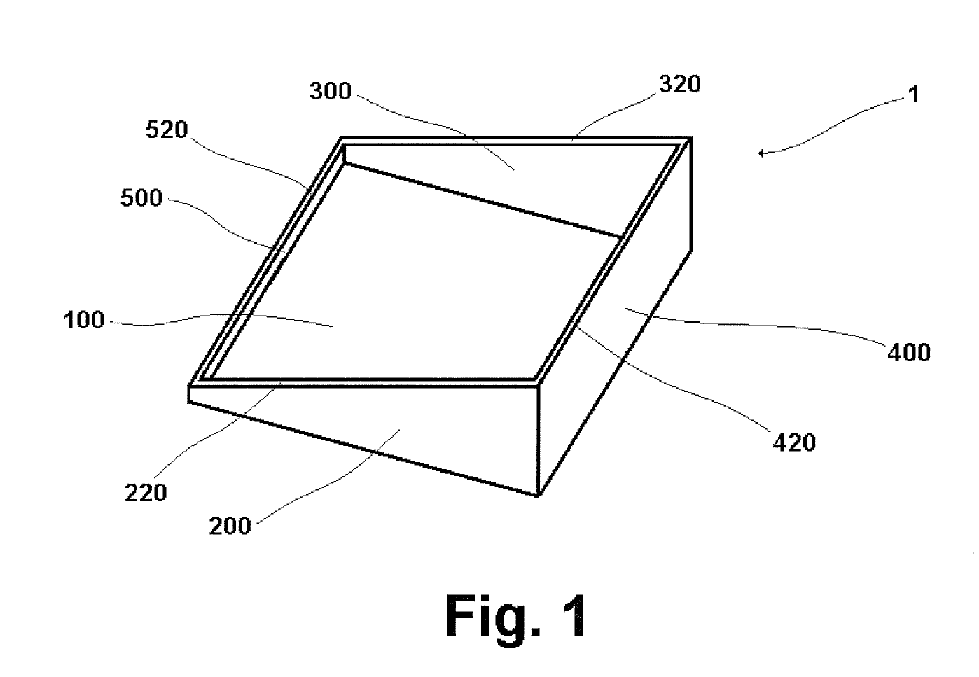

The support caddy device 1 is constructed of corrugated cardboard. It is comprised of a support panel 100, a first side panel 200, a second side panel 300, a back panel 400, and a front panel 500. See FIG. 1. Each of the panels may be separately formed and then attached to each other using any suitable attachment means, such as glue, adhesive tape, etc. Alternatively, multiple panels may be formed of a single sheet of corrugated cardboard. In the preferred embodiment all panels are formed of a single, unitary sheet of corrugated cardboard, which is then folded to achieve the appropriate shape of the supply caddy device 1 (see below).

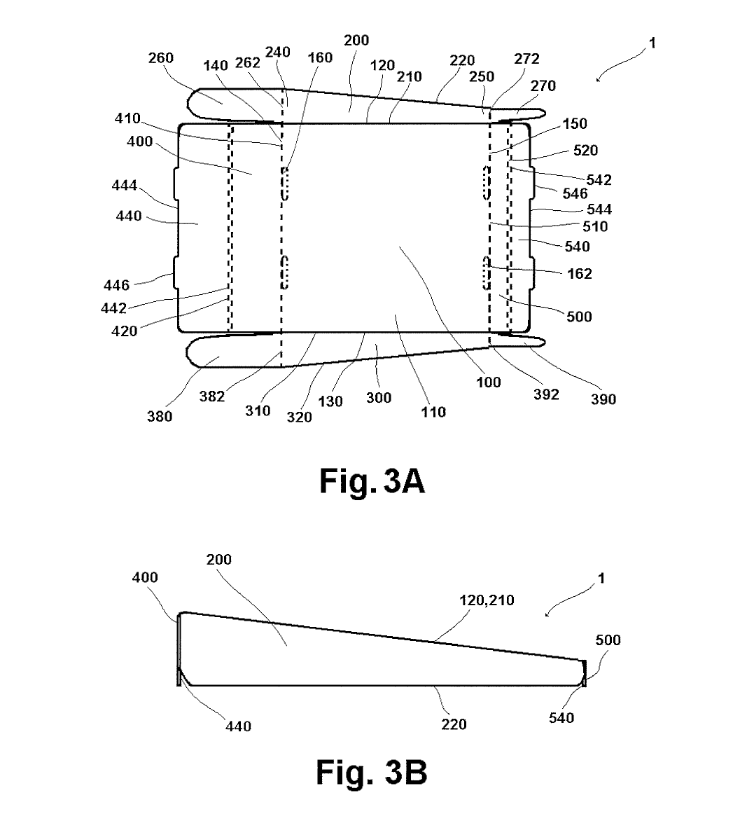

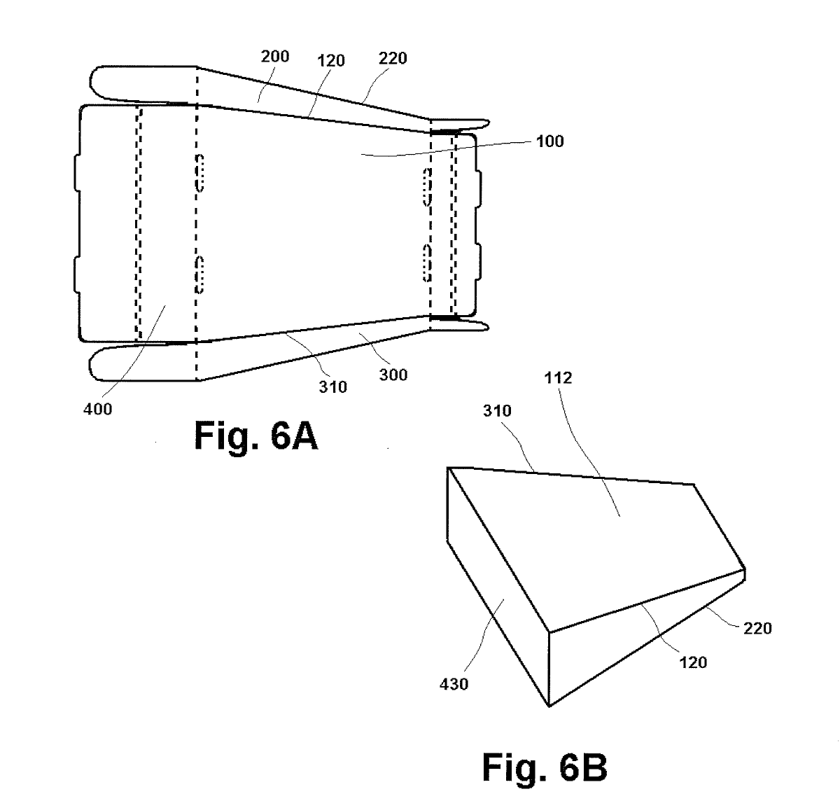

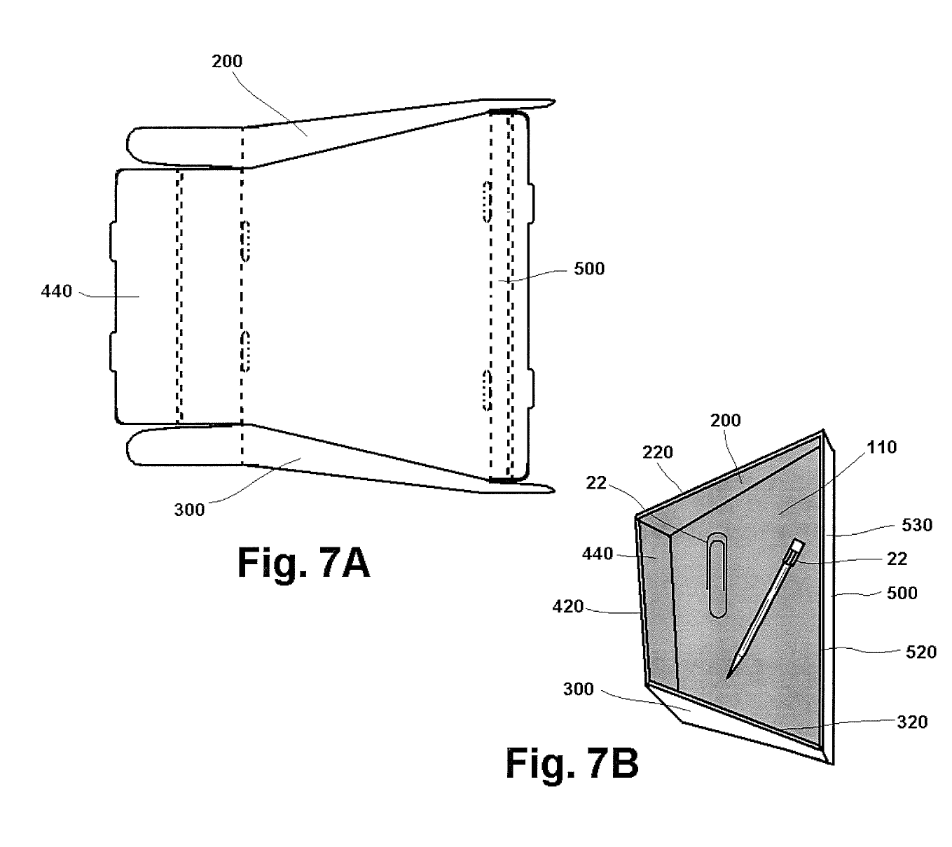

The support panel 100 is substantially planar and has an inner surface 110, an outer surface 112, a first side edge 120, a second side edge 130, a back edge 140, a front edge 150, a width (running from the first side edge 120 to the second side edge 130), and a depth (running from the front edge 150 to the back edge 140). See FIG. 3A. The support panel 100 is substantially rigid and suitably adapted to support objects 20,22 upon its inner and outer surfaces 110,112. The support panel 100 may be of any suitable shape. In the preferred embodiment the support panel 100 is a regular trapezoid, having substantially symmetrical opposing sides. In the most preferred embodiment the support panel 100 is substantially square. In other embodiments the support panel 100 may be rectangular, or narrower along its front edge 150 than along its back edge 140, see FIGS. 6A and 6B, or wider along its front edge 150 than along its back edge 140, see FIGS. 7A and 7B. In yet other embodiments the support panel 100 may be ovoid, circular, or other shapes having curved sides.

The first side panel 200 is substantially planar and substantially rigid, and has a back end 240, a front end 250, a back end height, a front end height, an inside edge 210, and a free edge 220. See FIGS. 3A and 3B. The first side panel 200 is located adjacent to the support panel 100 and oriented substantially perpendicular to the support panel 100, with the inside edge 210 of the first side panel 200 being coextensive with the first side edge 120 of the support panel 100. The first side panel's 200 free edge 220 is located opposite its inside edge 210 with the free edge 220 being substantially linear and angled relative to the inside edge 210. The free edge 220 angles towards the inside edge 210 from the back end 240 to the front end 250 of the first side panel 200, such that the back end height of the first side panel 200 is greater than the front end height. The relative angle between the inside edge 210 and the free edge 220 of the first side panel 200 reasonably corresponds to the angle of incline in the automobile seat 10 sitting surface 12.

The second side panel 300 is substantially planar and substantially rigid, and has a back end 340, a front end 350, a back end height, a front end height, an inside edge 310, and a free edge 320. See FIG. 3A. The second side panel 300 is located adjacent to the support panel 100 and oriented substantially perpendicular to the support panel 100, with the inside edge 310 of the second side panel 300 being coextensive with the second side edge 130 of the support panel 100. The second side panel 300 is configured substantially identically to the first side panel 200, such that the free edge 320 of the second side panel 300 is substantially parallel with the free edge 220 of the first side panel 200, the back end height of the second side panel 300 is substantially equal to the back end height of the first side panel 200, and the front end height of the second side panel 300 is substantially equal to the front end height of the first side panel 200.

The back panel 400 is substantially planar and substantially rigid, and has a back surface 430, a width, a height, an inside edge 410, and a free edge 420. See FIGS. 3A and 6B. The back panel 400 is located adjacent to the support panel 100 and oriented substantially perpendicular to the support panel 100, with the inside edge 410 of the back panel 400 coextensive with the back edge 140 of the support panel 100. The free edge 420 of the back panel 400 is located opposite the inside edge 410 of the back panel 400, with the free edge 420 being substantially parallel to the inside edge 410. The height of the back panel 400 is substantially equal to the back end heights of the first and second side panels 200,300, and the width of the back panel 400 is substantially equal to the width of the back edge 140 of the support panel 100. In the preferred embodiment the back panel 400 is substantially rectangular.

The front panel 500 is substantially planar and substantially rigid, and has a front surface 530, a width, a height, an inside edge 510, and a free edge 520. See FIGS. 3A and 7B. The front panel 500 is located adjacent to the support panel 100 and oriented substantially perpendicular to the support panel 100, with the inside edge 510 of the front panel 500 coextensive with the front edge 150 of the support panel 100. The free edge 520 of the front panel 500 is located opposite the inside edge 510 of the front panel 500, with the free edge 520 being substantially parallel to the inside edge 510. The height of the front panel 500 is substantially equal to the front end heights of the first and second side panels 200,300, and the width of the front panel 500 is substantially equal to the width of the front edge 150 of the support panel 100. In the preferred embodiment the front panel 500 is substantially rectangular and lies in a plane substantially parallel to a plane in which the back panel 400 lies.

Taken together, the first side panel 200, the back panel 400, the second side panel 300, and the front panel 500 form substantially vertical adjacent walls depending from the support panel 100, which forms a closed end to the support caddy device 1, such that the support caddy device 1 has a substantially open wedge shape. See FIG. 1. As such, the support caddy device 1 is suitably adapted to be placed on the automobile seat 10 sitting surface 12 in one of two orientations. The first orientation, designated the support caddy mode, is achieved by placing the support caddy device 1 onto the automobile seat 10 with the support panel 100 of the support caddy device 1 positioned downward so that the outer surface 112 of the support panel 100 is in at least partial contact with the automobile seat 10 sitting surface 12. In this mode, the first side panel 200, the second side panel 300, the back panel 400, and the front panel 500 each depend upward from the support panel 100, with their free edges 220,320,420,520 all lying in a substantially horizontal plane. The back surface 430 of the back panel 400 is positioned towards the seat back 14 of the automobile seat 10 and the front panel 500 is positioned towards the front of the sitting surface 12 of the automobile seat 10. In this mode the support caddy device 1 acts as a container for relatively small objects 22, which are placed within the support caddy device 1 upon the inner surface 110 of the support panel 100. See FIG. 7B. Larger objects 20 are supported on the free edges of two or more of the first side panel 200, the second side panel 300, the back panel 400, and the front panel 500 in a substantially horizontal orientation. Thus, the support caddy device 1 is used to simultaneously contain small objects 22 and support larger objects 20. As an example of the use of the support caddy device 1 in support caddy mode, plates, napkins, and forks can be placed within the support caddy device 1 while a pizza box 20 can be placed on the free edges 520,420,220,320 of the front, back, and side panels 500,400,200,300 in a substantially horizontal orientation.

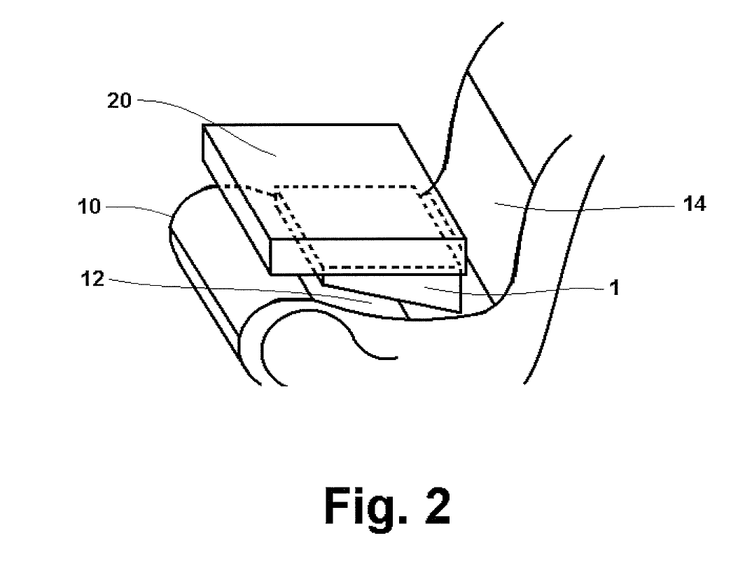

The second orientation of the support caddy device 1, designated the full support mode, is achieved by positioning the support caddy device 1 onto the automobile seat 10 with the support panel 100 of the support caddy device 1 oriented upward. The first side panel 200, the second side panel 300, the back panel 400, and the front panel 500 thus depend downward from the support panel 100, with their free edges 220,320,420,520 in at least partial contact with the automobile seat 10 sitting surface 12. See FIG. 2. In this mode, the support panel 100 is oriented substantially horizontally, with the back surface 430 of the back panel 400 oriented towards the seat back 14. Objects 20 are then placed upon the outer surface 112 of the support panel 100 in a substantially horizontal orientation. As an example of the use of the support caddy device 1 in full support mode, a full crock pot 20 can be placed onto the outer surface 112 of the support panel 100 of the support caddy device 1 in a substantially horizontal orientation.

The present invention lends itself to increased manufacturing efficiency. In the preferred embodiment, the panels 100,200,300,400,500 of the support caddy device 1 are constructed of a unitary sheet of corrugated cardboard. This sheet of corrugated cardboard is scored to permit it to be folded into the open wedge shape of the support caddy device 1. See FIG. 3A. In one embodiment the various panels may be secured in their desired positions relative to each other by external fasteners, such as strips of adhesive tape or one or more circumferential elastic bands.

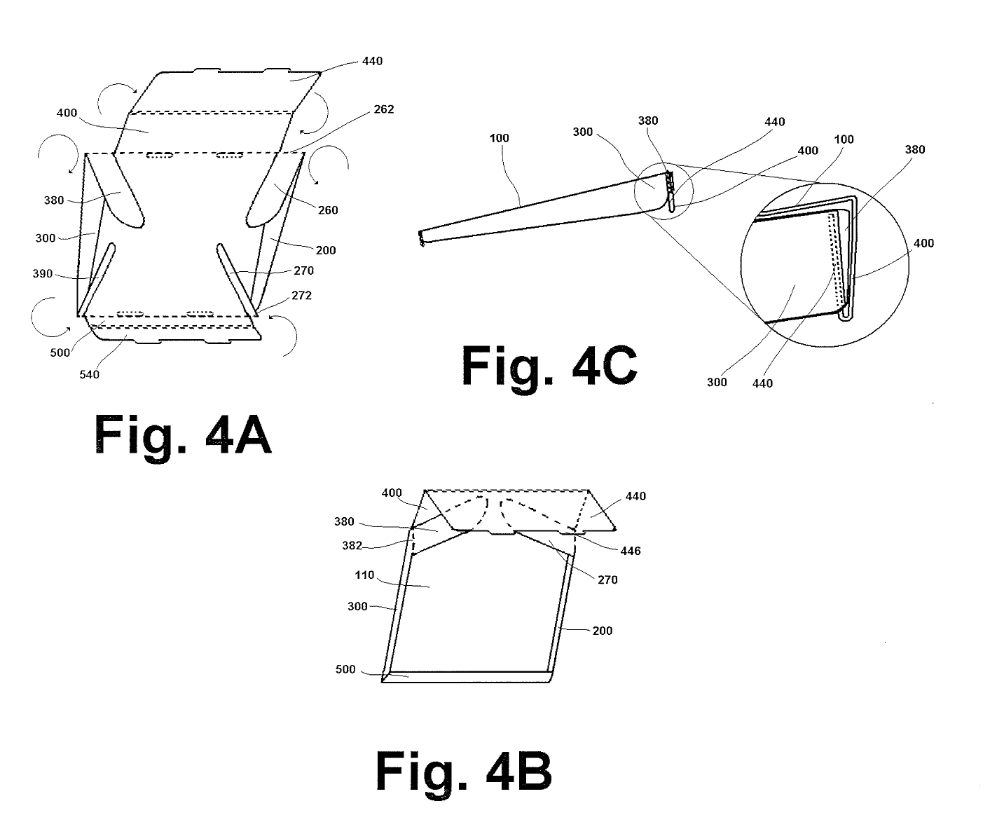

In the most preferred embodiment of a support caddy device 1 constructed of a unitary sheet of corrugated cardboard, the first and second side panels 200,300 and the front and back panels 500,400 comprise additional structures that allow the support caddy device 1 to be self-supporting in its desired configuration without the need for external fasteners. In this embodiment, the first side panel 200 comprises a first wing 260, a second wing 270, a first fold line 262, and a second fold line 272. The first wing 260 has a width and a length and depends from the back end 240 of the first side panel 200. The width of the first wing 260 is just slightly less than the height of the back panel 400 while the length of the first wing 260 is less than half the width of the support panel 100. Similarly, the second wing 270 has a width and a length and depends from the front end 250 of the first side panel 200. The width of the second wing 270 is just slightly less than the height of the front panel 500 while the length of the second wing 270 is less than half the width of the support panel 100. See FIG. 3A. The first fold line 262 is located at the junction of the first side panel 200 and the first wing 260 and is oriented substantially perpendicular to the length of the first wing 260 and substantially perpendicular to the first side edge 120 of the support panel 100. Likewise, the second fold line 272 is located at the junction of the first side panel 200 and the second wing 270 and is substantially perpendicular to the length of the second wing 270 and substantially perpendicular to the first side edge 120 of the support panel 100. In this configuration, the first wing 260 may be folded along the first fold line 262 such that it lies against a portion of the back panel 400, and the second wing 270 may be folded along the second fold line 272 such that it lies against a portion of the front panel 500. In the same manner, the second side panel 300 comprises a third wing 380, a fourth wing 390, a third fold line 382, and a fourth fold line 392, with the third and fourth wings 380,390 configured substantially the same as the first and second wings 260,270, respectively, and with the third and fourth fold lines 382,392 configured substantially the same as the first and second fold lines 262,272, respectively, such that the third wing 380 may be folded along the third fold line 382 such that it lies against a portion of the back panel 400, and the fourth wing 390 may be folded along the fourth fold line 392 such that it lies against a portion of the front panel 500. See FIGS. 4A and 4B.

This most preferred embodiment further comprises a back panel 400 having a back flap 440 and a front panel 500 having a front flap 540. The back flap 440 of the back panel 400 is substantially planar and has a width, a height, an inside edge 442, and a tuck edge 444. The back flap 440 is located adjacent to the back panel 400 with the inside edge 442 of the back flap 440 coextensive with the free edge of the back panel 400. The tuck edge 444 of the back flap 440 is located opposite the inside edge 442 of the back flap 440 with the tuck edge 444 of the back flap 440 being substantially parallel to the inside edge 442 of the back flap 440 and the tuck edge 444 of the back flap 440 is oriented towards the inside edge 410 of the back panel 400, such that the back flap 440 is oriented substantially parallel to and interior to the back panel 400. The height of the back flap 440 is substantially equal to the height of the back panel 400 and the width of the back panel 400 is substantially equal to the width of the support panel 100 along the back edge of the support panel 100. The front flap 540 of the front panel 500 is similarly configured, with a width, a height, an inside edge 542, and a tuck edge 544. The front flap 540 is located adjacent to the front panel 500 with the inside edge 542 of the front flap 540 coextensive with the free edge of the front panel 500. The tuck edge 544 of the front flap 540 is located opposite the inside edge 542 of the front flap 540 with the tuck edge 544 of the front flap 540 being substantially parallel to the inside edge 542 of the front flap 540 and the tuck edge 544 of the front flap 540 is oriented towards the inside edge 510 of the front panel 500, such that the front flap 540 is oriented substantially parallel to and interior to the front panel 500. The height of the front flap 540 is substantially equal to the height of the front panel 500 and the width of the front panel 500 is substantially equal to the width of the support panel 100 along the front edge of the support panel 100. In this configuration, the first and third wings 260,380 are positioned between the back panel 400 and the back flap 440, and the second and fourth wings 270,390 are positioned between the front panel 500 and the front flap 540. See FIG. 4C. So positioned, the wings add rigidity to and between adjacent panels.

In a variation of the most preferred embodiment, the tuck edge 444 of the back flap 440 of the back panel 400 comprises at least one back tab 446, and the support panel 100 comprises at least one back slot 160 proximate to its back edge 140. The number of back slots 160 is equal to the number of back tabs 446. Each back tab 446 is suitably adapted to be inserted into a corresponding back slot 160. Likewise, the tuck edge 544 of the front flap 540 of the front panel 500 comprises at least one front tab 546, and the support panel 100 comprises at least one front slot 162 proximate to its front edge 150. The number of front slots 162 is equal to the number of front tabs 546. Each front tab 546 is suitably adapted to be inserted into a corresponding front slot 162. With the back tabs 446 inserted into the back slots 160 and the front tabs 546 inserted into the front slots 162, the back and front flaps 440,540 remain securely in place, further improving the rigidity of the support caddy device 1. In alternative embodiments, only one or the other of the back flap 440 and front flap 540 has tabs and corresponding slots.

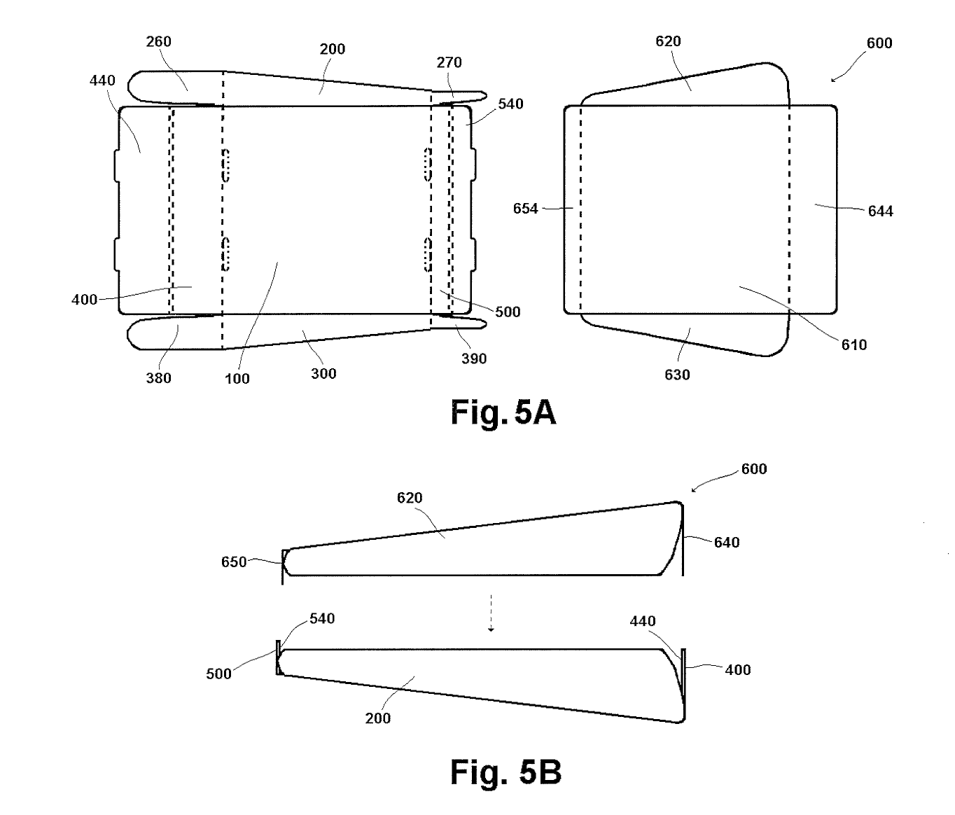

An alternative embodiment of the support caddy device 1 further comprises a cover 600. See FIG. 5B. The cover 600 is constructed of corrugated cardboard. The cover 600 has a support panel 610, a first side panel 620, a second side panel 630, a back panel 644, and a front panel 654, with these panels configured substantially the same as the support panel 100, first side panel 200, second side panel 300, back panel 400, and front panel 500 of the support caddy device 1 as described above and in relationship with each other in the same manner as the corresponding panels of the support caddy device 1. See FIG. 5A. However, each panel of the cover 600 is just slightly smaller than each corresponding panel of the support caddy device 1. Thus configured, the cover 600 has a substantially open wedge shape and is suitably adapted to be mated with the support caddy device 1. When mated, the back surface 430 of the back panel 644 of the cover 600 is proximate to and interior to the back panel 400 of the support caddy device 1, the front surface 530 of the front panel 654 of the cover 600 is proximate to and interior to the front panel 500 of the support caddy device 1, the first side panel 620 of the cover 600 is proximate to and interior to the first side panel 200 of the support caddy device 1, the second side panel 630 of the cover 600 is proximate to and interior to the second side panel 300 of the support caddy device 1, the inner surface 614 of the support panel 610 of the cover 600 is oriented towards the inner surface 110 of the support panel 100 of the support caddy device 1, and the support panel 610 of the cover 600 lies substantially in the same plane as the free edges 220,320,420,520 of the first side panel 200, the second side panel 300, the back panel 400, and the front panel 500 of the support caddy device 1. The cover 600 allows the support caddy device 1 to be used in support caddy mode and in full support mode simultaneously, in that smaller objects 22 may be placed within the hollow cavity formed by the mating of the cover 600 with the support caddy device 1 while larger objects 20 may be placed on either the support panel 100 of the support caddy device 1 or on the support panel 610 of the cover 600.

The cover 600 may be constructed of a unitary sheet of corrugated cardboard, and scored to permit the sheet of cardboard to be folded. In this configuration, the support panel 610, first side panel 620, second side panel 630, back panel 644, and front panel 654 of the cover 600 further comprise structures equivalent to the first wing 260, second wing 270, third wing 380, fourth wing 390, back flap 440, and front flap 540 of the support caddy device 1, as described above. These structures are adapted to be folded and positioned in the cover 600 in the same manner as the corresponding structures of the support caddy device 1.

In an alternative embodiment, the cover 600 is hingedly attached to the support caddy device 1. In yet another alternative embodiment, the front panel 654 of the cover 600 is coextensive with the front panel 500 of the support caddy device 1.

Modifications and variations may be made to the disclosed embodiments of the present invention without departing from the subject or spirit of the present invention as defined in the following claims.

1. A support caddy device for placing on an automobile seat sitting surface, said support caddy device constructed of corrugated cardboard and comprising
a support panel, said support panel being substantially planar and having an inner surface, an outer surface, a first side edge, a second side edge, a back edge, a front edge, a width, and a depth, said support panel being substantially rigid and suitably adapted to support objects on its inner and outer surfaces;
a first side panel, said first side panel being substantially planar and having a back end, a front end, a back end height, a front end height, an inside edge, and a free edge, said first side panel being substantially rigid, said free edge located opposite the inside edge and said free edge being substantially linear and angled relative to the inside edge from the back end to the front end such that the back end height is greater than the front end height, said relative angle between the inside edge and the free edge of the first side panel reasonably corresponding to an angle of incline in the automobile seat sitting surface, with said first side panel located adjacent to the support panel and oriented substantially perpendicular to the support panel, the first side edge of the support panel being coextensive with the inside edge of the first side panel;
a second side panel, said second side panel being substantially planar and having a back end, a front end, a back end height, a front end height, an inside edge, and a free edge, said second side panel being substantially rigid, said free edge located opposite the inside edge and said free edge being substantially linear and angled substantially identically as the corresponding free edge of the first side panel such that the free edge of the second side panel is substantially parallel with the free edge of the first side panel, the back end height of the second side panel being substantially equal to the back end height of the first side panel and the front end height of the second side panel being substantially equal to the front end height of the first side panel, with said second side panel located adjacent to the support panel and oriented substantially perpendicular to the support panel, the second side edge of the support panel being coextensive with the inside edge of the second side panel;
a back panel, said back panel being substantially planar and having a back surface, a width, a height, an inside edge, and a free edge, said back panel being substantially rigid, said free edge located opposite the inside edge and said free edge being substantially parallel to the inside edge, the height of the back panel being substantially equal to the back end height of the first side panel, with said back panel located adjacent to the support panel and oriented substantially perpendicular to the support panel, the back edge of the support panel coextensive with the inside edge of the back panel; and
a front panel, said front panel being substantially planar and having a front surface, a width, a height, an inside edge, and a free edge, said front panel being substantially rigid, said free edge located opposite the inside edge and said free edge being substantially parallel to the inside edge, the height of the front panel being substantially equal to the front end height of the first side panel, with said front panel oriented substantially perpendicular to the support panel and located adjacent to the support panel, the front edge of the support panel coextensive with the inside edge of the front panel;
whereby the support caddy device has a substantially open wedge shape and is suitably adapted to be placed on the automobile seat sitting surface in either a support caddy mode or in a full support mode,
with the support caddy mode being achieved by positioning the support caddy device relative to the automobile seat with the support panel of the support caddy device oriented downward with the outer surface of the support panel in at least partial contact with the automobile seat sitting surface, the first side panel, the second side panel, the back panel, and the front panel each depending upward, with the free edges of the first side panel, the second side panel, the back panel, and the front panel lying in a substantially horizontal plane, and with the back surface of the back panel oriented towards a seat back of the automobile seat, whereby smaller objects may be placed within the support caddy device upon the inner surface of the support panel and larger objects may be supported on the free edges of two or more of the first side panel, the second side panel, the back panel, and the front panel in a substantially horizontal orientation, and
the full support mode being achieved by positioning the support caddy device relative to the automobile seat with the support panel of the support caddy device oriented upward and the first side panel, the second side panel, the back panel, and the front panel each depending downward, with the free edges of the first side panel, the second side panel, and the back panel in at least partial contact with the automobile seat sitting surface, with the support panel oriented substantially horizontally, and with the back surface of the back panel oriented towards the seat back of the automobile seat, whereby objects may be placed upon the outer surface of the support panel in a substantially horizontal orientation.

2. The support caddy device of claim 1 wherein
the support panel is a regular trapezoid;
the back panel is substantially rectangular; and
the front panel is substantially rectangular.

3. The support caddy device of claim 2 wherein the support panel is substantially rectangular.

4. The support caddy device of claim 3 wherein the support panel is substantially square.

5. The support caddy device of claim 1 wherein the width of the front panel is substantially the same as the width of the back panel.

6. The support caddy device of claim 1 wherein the width of the front panel is less than the width of the back panel.

7. The support caddy device of claim 1 wherein the width of the front panel is greater than the width of the back panel.

8. The support caddy device of claim 1 wherein the support panel, the first side panel, the second side panel, the back panel, and the front panel are constructed of a unitary sheet of corrugated cardboard;
whereby said sheet of corrugated cardboard is scored to permit it to be folded into the open wedge shape of the support caddy device.

9. The support caddy device of claim 8 wherein
the first side panel further comprises
a first wing, said first wing having a width and a length and depending from the back end of the first side panel, the width of the first wing being just slightly less than the height of the back panel and said length of the first wing being less than half the width of the support panel,
a first fold line, said first fold line being located at the junction of the first side panel and the first wing and being substantially perpendicular to the length of the first wing and substantially perpendicular to the first side edge of the support panel,
a second wing, said second wing having a width and a length and depending from the front end of the first side panel, the width of the second wing being just slightly less than the height of the front panel and said length of the second wing being less than half the width of the support panel, and
a second fold line, said second fold line being located at the junction of the first side panel and the second wing and being substantially perpendicular to the length of the second wing and substantially perpendicular to the first side edge of the support panel;
the second side panel further comprises
a third wing, said third wing having a width and a length and depending from the back end of the second side panel, the width of the third wing being just slightly less than the height of the back panel and said length of the third wing being less than half the width of the support panel,
a third fold line, said third fold line being located at the junction of the second side panel and the third wing and being substantially perpendicular to the length of the third wing and substantially perpendicular to the second side edge of the support panel,
a fourth wing, said fourth wing having a width and a length and depending from the front end of the second side panel, the width of the fourth wing being just slightly less than the height of the front panel and said length of the fourth wing being less than half the width of the support panel, and
a fourth fold line, said fourth fold line being located at the junction of the second side panel and the fourth wing and being substantially perpendicular to the length of the fourth wing and substantially perpendicular to the second side edge of the support panel;
the back panel further comprises
a back flap, with said back flap being substantially planar and having a width, a height, an inside edge, and a tuck edge, said tuck edge of the back flap located opposite the inside edge of the back flap and said tuck edge of the back flap being substantially parallel to the inside edge of the back flap, the height of the back flap being substantially equal to the height of the back panel, with said back flap located adjacent to the back panel with the inside edge of the back flap coextensive with the free edge of the back panel and the tuck edge of the back flap oriented towards the inside edge of the back panel, such that the back flap is oriented substantially parallel to and interior to the back panel; and
the front panel further comprises
a front flap, with said front flap being substantially planar and having a width, a height, an inside edge, and a tuck edge, said tuck edge of the front flap located opposite the inside edge of the front flap and said tuck edge of the front flap being substantially parallel to the inside edge of the front flap, the height of the front flap being substantially equal to the height of the front panel, with said front flap located adjacent to the front panel with the inside edge of the front flap coextensive with the free edge of the front panel and the tuck edge of the front flap oriented towards the inside edge of the front panel, such that the front flap is oriented substantially parallel to and interior to the front panel;
wherein the first side edge, the second side edge, the back edge, and the front edge of the support panel are scored to allow the sheet of corrugated cardboard to be folded along said edges,
the free edge of the back panel is scored to allow the sheet of corrugated cardboard to be folded along said edge,
the free edge of the front panel is scored to allow the sheet of corrugated cardboard to be folded along said edge,
the first fold line is scored to allow the sheet of corrugated cardboard to be folded along said first fold line with the first wing folded along the first fold line and positioned between the back panel and the back flap of the back panel, thereby adding rigidity to the back panel and first side panel,
the second fold line is scored to allow the sheet of corrugated cardboard to be folded along said second fold line with the second wing folded along the second fold line and positioned between the front panel and the front flap of the front panel, thereby adding rigidity to the front panel and first side panel,
the third fold line is scored to allow the sheet of corrugated cardboard to be folded along said third fold line with the third wing folded along the third fold line and positioned between the back panel and the back flap of the back panel, thereby adding rigidity to the back panel and second side panel, and
the fourth fold line is scored to allow the sheet of corrugated cardboard to be folded along said fourth fold line with the fourth wing folded along the fourth fold line and positioned between the front panel and the front flap of the front panel, thereby adding rigidity to the front panel and second side panel.

10. The support caddy device of claim 9 wherein
the tuck edge of the back flap of the back panel comprises at least one back tab, and
the support panel comprises at least one back slot proximate to the back edge of the support panel, the number of said back slots equal to the number of said back tabs,
with each said back tab suitably adapted to be inserted into a corresponding back slot.

11. The support caddy device of claim 9 wherein
the tuck edge of the front flap of the front panel comprises at least one front tab, and
the support panel comprises at least one front slot proximate to the front edge of the support panel, the number of said front slots equal to the number of said front tabs,
with each said front tab suitably adapted to be inserted into a corresponding front slot.

12. The support caddy device of claim 1 further comprising a cover, said cover constructed of corrugated cardboard and comprising
a support panel, a first side panel, a second side panel, a back panel, and a front panel, with the support panel, first side panel, second side panel, back panel, and front panel of the cover configured substantially the same as the support panel, first side panel, second side panel, back panel, and front panel of the support caddy device of claim 1, respectively, with each said panel of the cover being just slightly smaller than each corresponding panel of the support caddy device of claim 1, and with said panels of the cover in relationship with each other in the same manner as the corresponding panels of the support caddy device of claim 1,
whereby the cover has a substantially open wedge shape and is suitably adapted to be mated with the support caddy device of claim 1 such that the back surface of the back panel of the cover is proximate to and interior to the back panel of the support caddy device of claim 1,
the front surface of the front panel of the cover is proximate to and interior to the front panel of the support caddy device of claim 1,
the first side panel of the cover is proximate to and interior to the first side panel of the support caddy device of claim 1,
the second side panel of the cover is proximate to and interior to the second side panel of the support caddy device of claim 1,
the inner surface of the support panel of the cover is oriented towards the inner surface of the support panel of the support caddy device of claim 1, and
the support panel of the cover lies substantially in the same plane as the free edges of the first side panel, the second side panel, the back panel, and the front panel of the support caddy device of claim 1,
with the support caddy device suitably adapted to be used in support caddy mode and in full support mode simultaneously by placing smaller objects within a hollow cavity formed by the mating of the cover with the support caddy device of claim 1 and by placing larger objects on either the support panel of the support caddy device of claim 1 or on the support panel of the cover.

13. The support caddy device of claim 12 wherein the cover is hingedly attached to the support caddy device of claim 1.

14. The support caddy device of claim 13 wherein the front panel of the cover is coextensive with the front panel of the support caddy device of claim 1.

15. The support caddy device of claim 9 further comprising a cover, said cover constructed of a unitary sheet of corrugated cardboard, said sheet of corrugated cardboard being scored to permit it to be folded, said cover comprising
a support panel, a first side panel, a second side panel, a back panel, a front panel, a first wing, a second wing, a third wing, a fourth wing, a back flap, and a front flap, with the support panel, first side panel, second side panel, back panel, front panel, first wing, second wing, third wing, fourth wing, back flap, and front flap of the cover configured substantially identically to the support panel, first side panel, second side panel, back panel, front panel, first wing, second wing, third wing, fourth wing, back flap, and front flap of the support caddy device of claim 9, respectively, with each said panel of the cover being just slightly smaller than each corresponding panel of the support caddy device of claim 9, and with said panels of the cover interrelated with each other in the same manner as the corresponding panels of the support caddy device of claim 9 and with said panels of the cover being folded in the same manner as the corresponding panels of the support caddy device of claim 9,
whereby the cover has a substantially open wedge shape and is suitably adapted to be mated with the support caddy device of claim 9 such that the back surface of the back panel of the cover is proximate to and interior to the back flap of the back panel of the support caddy device of claim 9,
the front surface of the front panel of the cover is proximate to and interior to the front flap of the front panel of the support caddy device of claim 9,
the first side panel of the cover is proximate to and interior to the first side panel of the support caddy device of claim 9,
the second side panel of the cover is proximate to and interior to the second side panel of the support caddy device of claim 9,
the inner surface of the support panel of the cover is oriented towards the inner surface of the support panel of the support caddy device of claim 9, and
the support panel of the cover lies substantially in the same plane as the free edges of the first side panel, the second side panel, the back panel, and the front panel of the support caddy device of claim 9,
with the support caddy device suitably adapted to be used in support caddy mode and in full support mode simultaneously by placing smaller objects within a hollow cavity formed by the mating of the cover with the support caddy device of claim 9 and by placing larger objects on either the support panel of the support caddy device of claim 9 or on the support panel of the cover.

16. A support caddy device for placing on an automobile seat sitting surface, said support caddy device constructed of corrugated cardboard and comprising
a support panel, said support panel being substantially planar and having an inner surface, an outer surface, a first side edge, a second side edge, a back edge, a front edge, a width, and a depth, said support panel being substantially rigid and suitably adapted to support objects on its inner and outer surfaces;
a first side panel, said first side panel being substantially planar and having a back end, a front end, a back end height, a front end height, an inside edge, and a free edge, said first side panel being substantially rigid, said free edge located opposite the inside edge and said free edge being substantially linear and angled relative to the inside edge from the back end to the front end such that the back end height is greater than the front end height, said relative angle between the inside edge and the free edge of the first side panel reasonably corresponding to an angle of incline in the automobile seat sitting surface, with said first side panel located adjacent to the support panel and oriented substantially perpendicular to the support panel, the first side edge of the support panel being coextensive with the inside edge of the first side panel;
a second side panel, said second side panel being substantially planar and having a back end, a front end, a back end height, a front end height, an inside edge, and a free edge, said second side panel being substantially rigid, said free edge located opposite the inside edge and said free edge being substantially linear and angled substantially identically as the corresponding free edge of the first side panel such that the free edge of the second side panel is substantially parallel with the free edge of the first side panel, the back end height of the second side panel being substantially equal to the back end height of the first side panel and the front end height of the second side panel being substantially equal to the front end height of the first side panel, with said second side panel located adjacent to the support panel and oriented substantially perpendicular to the support panel, the second side edge of the support panel being coextensive with the inside edge of the second side panel; and
a back panel, said back panel being substantially planar and having a back surface, a width, a height, an inside edge, and a free edge, said back panel being substantially rigid, said free edge located opposite the inside edge and said free edge being substantially parallel to the inside edge, the height of the back panel being substantially equal to the back end height of the first side panel, with said back panel located adjacent to the support panel and oriented substantially perpendicular to the support panel, the back edge of the support panel coextensive with the inside edge of the back panel;
whereby the support caddy device has a substantially open wedge shape and is suitably adapted to be placed on the automobile seat sitting surface in either a support caddy mode or in a full support mode,
with the support caddy mode being achieved by positioning the support caddy device relative to the automobile seat with the support panel of the support caddy device oriented downward with the outer surface of the support panel in at least partial contact with the automobile seat sitting surface, the first side panel, the second side panel, and the back panel each depending upward, with the free edges of the first side panel, the second side panel, and the back panel lying in a substantially horizontal plane, and with the back surface of the back panel oriented towards a seat back of the automobile seat, whereby smaller objects may be placed within the support caddy device upon the inner surface of the support panel and larger objects may be supported on the free edges of two or more of the first side panel, the second side panel, and the back panel in a substantially horizontal orientation, and
the full support mode being achieved by positioning the support caddy device relative to the automobile seat with the support panel of the support caddy device oriented upward and the first side panel, the second side panel, and the back panel each depending downward, with the free edges of the first side panel, the second side panel, and the back panel in at least partial contact with the automobile seat sitting surface, with the support panel oriented substantially horizontally, and with the back surface of the back panel oriented towards the seat back of the automobile seat, whereby objects may be placed upon the outer surface of the support panel in a substantially horizontal orientation.

17. The support caddy device of claim 16 wherein the support panel, the first side panel, the second side panel, and the back panel are constructed of a unitary sheet of corrugated cardboard;
whereby said sheet of corrugated cardboard is scored to permit it to be folded into the open wedge shape of the support caddy device.

18. The support caddy device of claim 17 wherein
the first side panel further comprises
a first wing, said first wing having a width and a length and depending from the back end of the first side panel, the width of the first wing being just slightly less than the height of the back panel and said length of the first wing being less than half the width of the support panel, and
a first fold line, said first fold line being located at the junction of the first side panel and the first wing and being substantially perpendicular to the length of the first wing and substantially perpendicular to the first side edge of the support panel;
the second side panel further comprises
a second wing, said second wing having a width and a length and depending from the back end of the second side panel, the width of the second wing being just slightly less than the height of the back panel and said length of the second wing being less than half the width of the support panel, and
a second fold line, said second fold line being located at the junction of the second side panel and the second wing and being substantially perpendicular to the length of the second wing and substantially perpendicular to the second side edge of the support panel; and
the back panel further comprises
a back flap, with said back flap being substantially planar and having a width, a height, an inside edge, and a tuck edge, said tuck edge of the back flap located opposite the inside edge of the back flap and said tuck edge of the back flap being substantially parallel to the inside edge of the back flap, the height of the back flap being substantially equal to the height of the back panel, with said back flap located adjacent to the back panel with the inside edge of the back flap coextensive with the free edge of the back panel and the tuck edge of the back flap oriented towards the inside edge of the back panel, such that the back flap is oriented substantially parallel to and interior to the back panel;
wherein the first side edge, the second side edge, the back edge, and the front edge of the support panel are scored to allow the sheet of corrugated cardboard to be folded along said edges,
the free edge of the back panel is scored to allow the sheet of corrugated cardboard to be folded along said edge,
the first fold line is scored to allow the sheet of corrugated cardboard to be folded along said first fold line with the first wing folded along the first fold line and positioned between the back panel and the back flap of the back panel, thereby adding rigidity to the back panel and first side panel, and
the second fold line is scored to allow the sheet of corrugated cardboard to be folded along said second fold line with the second wing folded along the second fold line and positioned between the back panel and the back flap of the back panel, thereby adding rigidity to the back panel and second side panel.

19. The support caddy device of claim 18 wherein
the tuck edge of the back flap of the back panel comprises at least one back tab, and
the support panel comprises at least one back slot proximate to the back edge of the support panel, the number of said back slots equal to the number of said back tabs,
with each said back tab suitably adapted to be inserted into a corresponding back slot.

20. The support caddy device of claim 16 wherein
the support panel is substantially square; and
the back panel is substantially rectangular.
